(19) United States
(12) Patent Application Publication
(10) Pub. No.: US 2025/0384771 A1
(43) Pub. Date: Dec. 18, 2025

(54) METHOD AND DEVICE FOR PROVIDING SAFE DRIVING OF VEHICLE

(71) Applicants: HYUNDAI MOTOR COMPANY, Seoul (KR); KIA CORPORATION, Seoul (KR)

(72) Inventors: Jungmo Yu, Hwaseong-si (KR); Dokon Kim, Hwaseong-si (KR); Chan Seok Choi, Hwaseong-si (KR); Sae Yong Jang, Hwaseong-si (KR); HyeonSeob Kim, Hwaseong-si (KR); Gwangseob Kim, Hwaseong-si (KR)

(73) Assignees: HYUNDAI MOTOR COMPANY, Seoul (KR); KIA CORPORATION, Seoul (KR)

(21) Appl. No.: 18/967,634

(22) Filed: Dec. 3, 2024

(30) Foreign Application Priority Data
Jun. 12, 2024 (KR) 10-2024-0076032

(51) Int. Cl. G08G 1/16; G01C 21/34; G06V 20/58

(52) U.S. Cl. CPC G08G 1/164; G01C 21/3415; G06V 20/58

(57) ABSTRACT

A safe driving providing method and device for a vehicle for logistics delivery is provided. The method includes determining whether a condition is satisfied in which a safe driving providing mode is activated in a user setting mode (USM), a key is at an ignition one (IGN1), and a vehicle speed of the vehicle is less than a predetermined speed. When the condition is satisfied, the method determines a gear position of the vehicle, and, when the gear position is D, measuring a height of a topmost end from the ground through a front-facing camera mounted on the vehicle. The method also includes determining a grade of a forward collision warning level, outputting the graded level through an interface, and transmitting data of the height of the topmost end and position data of the vehicle to a server by using a central communication unit (CCU) of the vehicle.

### CROSS-REFERENCE TO RELATED APPLICATION(S)

This application claims priority to and the benefit of Korean Patent Application No. 10-2024-0076032 filed in the Korean Intellectual Property Office on Jun. 12, 2024, the entire contents of which are incorporated herein by reference.

### TECHNICAL FIELD

The disclosure relates to a method and device for providing safe driving of a vehicle, and more specifically to a method and device for providing safe driving of a cargo vehicle for logistics delivery.

### BACKGROUND

Cargo vehicles for logistics delivery serve to transport goods quickly and safely to various delivery destinations. When the delivery destination is a building, cargo vehicles may frequently enter and exit underground parking lots, where designing cargo vehicles for collision avoidance may be useful because of the limited height and width of underground parking lots and the tight spaces in which the cargo vehicles are often driven. For example, vehicle drivers' estimation of height to determine whether a vehicle may pass is not (e.g., consistently) accurate, which may lead to vehicles colliding with the ceiling of an underground parking lot or with obstacles located on the ceiling. As another example, a lack of rearward visibility or failure to recognize unevenness may result in a collision when the vehicle is reversing. Therefore, it may be useful to have a method and/or a system to minimize or prevent possible collisions of vehicles at delivery destinations and to enhance safety.

### SUMMARY

The present disclosure is to provide a method and device for providing safe driving of a vehicle to prevent a vehicle collision accident, such as a front top collision or a rear uneven obstacle collision, at a delivery destination, such as an underground parking lot, and prevent a collision by sharing terrain information about the delivery destination with other vehicles.

An example embodiment of the present disclosure provides a safe driving providing method of providing safe driving of a cargo vehicle for logistics delivery, the safe driving providing method including determining whether a condition is satisfied in which a safe driving providing mode is set to be activated in a user setting mode (USM), a key is located at an ignition one (IGN1), and a vehicle speed of the cargo vehicle is less than a predetermined reference speed, when it is determined that the condition is satisfied, determining a gear position of the cargo vehicle, when the gear position is D, measuring a height of a topmost end from the ground through a front-facing camera mounted on a front face of the cargo vehicle, determining a grade of a forward collision warning level by using the measured height and an overall height of the cargo vehicle, outputting the graded forward collision warning level through one or more output interfaces installed in the vehicle, and transmitting data of the height of the topmost end and position data of the cargo vehicle at a time of measuring the height of the topmost end to a server by using a central communication unit (CCU) of the cargo vehicle.

In some example embodiments, the determining of the grade of the forward collision warning level may include determining the forward collision warning level to be a first grade when a difference between the height of the topmost end and the overall height of the cargo vehicle is a first value, and determining the forward collision warning level to be a second grade when the difference between the height of the topmost end and the overall height of the cargo vehicle is a second value which is smaller than the first value.

In some example embodiments, the determining of the grade of the forward collision warning level may further include determining the forward collision warning level to be a third grade when the difference between the height of the topmost end and the overall height of the cargo vehicle is a third value which is smaller than the second value.

In some example embodiments, the safe driving providing method may further include, when the gear position is R, detecting an obstacle having a predetermined height or more through a rear-facing ultrasonic sensor mounted on a rear face of the cargo vehicle, determining a grade of the rearward collision warning level by using a distance between the detected obstacle and the cargo vehicle, and outputting the graded rearward collision warning level through one or more output interfaces installed in the vehicle.

In some example embodiments, the determining of the grade of the rearward collision warning level may include determining the rearward collision warning level to be a first grade when the distance between the detected obstacle and the cargo vehicle is equal to or less than a first value, and determining the rearward collision warning level to be a second grade when the distance between the detected obstacle and the cargo vehicle is equal to or less than a second value which is smaller than the first value.

In some example embodiments, the determining of the grade of the rearward collision warning level may further include determining the rearward collision warning level to be a third grade when the distance between the detected obstacle and the cargo vehicle is a third value which is smaller than the second value.

Another example embodiment of the present disclosure provides a safe driving providing method of providing safe driving of a cargo vehicle for logistics delivery, the safe driving providing method including receiving, from a cargo vehicle, data of a height of the topmost end obtained by measuring the height of the topmost end from the ground through a front-facing camera mounted on a front face of the cargo vehicle, receiving position data of the cargo vehicle at a time of measuring the height of the topmost end, computing an average value by collecting the N data of the height of the topmost end for the same location (N is an integer equal to or greater than 2), receiving N+1^{th} data of the height of the topmost end for the same location; comparing the N+1^{th} received data of the height of the topmost end with the average value to determine whether there is a change of a predetermined first percentage or more, and when it is determined that there is the change of the first percentage or more, reflecting the data of the height of the topmost end in dispatching and route generation of other cargo vehicles for logistics delivery.

In some example embodiments, the reflecting of the height of the topmost end into the dispatching and route generation of the other cargo vehicles for logistics delivery may include computing an enterable vehicle height value based on the data of the height of the topmost end, obtaining disposed vehicle height values for the other cargo vehicles for logistics delivery, discovering a disposing impossible route based on the enterable vehicle height value and the disposed vehicle height value, and performing the dispatching and route generation by taking into account of the discovered disposing impossible route.

In some example embodiments, the performing of the dispatching and route generation by taking into account of the discovered disposing impossible route may include additionally disposing a vehicle on a route of which a final route changes the least among vehicles disposed on routes that satisfy the vehicle height on the disposing impossible route.

In some example embodiments, the safe driving providing method may further include receiving, from the cargo vehicle, data of a width of a front region obtained by measuring a width of the front region through the front-facing camera, receiving position data of the cargo vehicle at a time of measuring the width of the front region; computing an average value by collecting the M data of the width of the front region for the same location (M is an integer equal to or greater than 2), receiving M+1^{th} data of the width of the front region for the same location; comparing the M+1^{th} received data of the width of the front region with the average value to determine whether there is a change of a predetermined second percentage or more, and when it is determined that there is the change of the second percentage or more, reflecting the data of the width of the front region in dispatching and route generation of other cargo vehicles for logistics delivery.

In some example embodiments, the safe driving providing method may further include sharing information indicative of presence of a terrain change based on at least one of the data of the height of the topmost end and the data of the width of the front region to another external server.

In some example embodiments, the safe driving providing method may further include receiving, from the cargo vehicle, data of an impassable situation of the front region obtained by recognizing the impassable situation of the front region through the front-facing camera, receiving position data of the cargo vehicle at a time of recognizing the impassable situation of the front region, and reflecting the data of the impassable situation into the dispatching and route generation of other cargo vehicles for logistics deliveries.

In some example embodiments, the safe driving providing method may further include receiving, from the cargo vehicle, collision occurrence situation data obtained by recognizing a collision occurrence situation of the cargo vehicle, receiving position data of the cargo vehicle upon recognizing the collision occurrence situation of the cargo vehicle, and reflecting the collision occurrence situation data in the dispatching and route generation of other cargo vehicles for logistics delivery.

In some example embodiments, the reflecting of the collision occurrence situation data in the dispatching and route generation of other cargo vehicles for logistics delivery may include obtaining data indicative of the number of times of vehicle trips at a specific point, computing a collision occurrence rate for the point by using the data representing the number of times of the vehicle trips and the collision occurrence situation data, and displaying the collision occurrence rate on a navigation map.

Still another example embodiment of the present disclosure provides a safe driving providing device for providing safe driving of a cargo vehicle for logistics delivery, the safe driving providing device executing a program code loaded in one or more memory devices through one or more processors, wherein the program code is executed to determine whether a condition is satisfied in which a safe driving providing mode is set to be activated in a user setting mode (USM), a key is located at an ignition one (IGN1), and a vehicle speed of the cargo vehicle is less than a predetermined reference speed, when it is determined that the condition is satisfied, determine a gear position of the cargo vehicle, when the gear position is D, measure a height of a topmost end from the ground through a front-facing camera mounted on a front face of the cargo vehicle, determine a grade of a forward collision warning level by using the measured height and an overall height of the cargo vehicle, output the graded forward collision warning level through one or more output interfaces installed in the vehicle, and transmit data of the height of the topmost end and position data of the cargo vehicle at a time of measuring the height of the topmost end to a server by using a central communication unit (CCU) of the cargo vehicle.

In some example embodiments, the determining of the grade of the forward collision warning level may include determining the forward collision warning level to be a first grade when a difference between the height of the topmost end and the overall height of the cargo vehicle is a first value, and determining the forward collision warning level to be a second grade when the difference between the height of the topmost end and the overall height of the cargo vehicle is a second value which is smaller than the first value.

In some example embodiments, the determining of the grade of the forward collision warning level may further include determining the forward collision warning level to be a third grade when the difference between the height of the topmost end and the overall height of the cargo vehicle is a third value which is smaller than the second value.

In some example embodiments, the program code may be executed to further detect an obstacle having a predetermined height or more when the gear position is R through a rear-facing ultrasonic sensor mounted on a rear face of the cargo vehicle, determine a grade of the rearward collision warning level by using a distance between the detected obstacle and the cargo vehicle, and output the graded rearward collision warning level through one or more output interfaces installed in the vehicle.

In some example embodiments, the determining of the grade of the rearward collision warning level may include determining the rearward collision warning level to be a first grade when the distance between the detected obstacle and the cargo vehicle is equal to or less than a first value, and determining the rearward collision warning level to be a second grade when the distance between the detected obstacle and the cargo vehicle is equal to or less than a second value which is smaller than the first value.

In some example embodiments, the determining of the grade of the rearward collision warning level may further include determining the rear collision warning level to be a third grade when the distance between the detected obstacle and the cargo vehicle is a third value which is smaller than the second value.

Forward Collision-Avoidance Assist (FCA) has a function of recognizing the distance to a vehicle or pedestrian in front of the vehicle through a distance detection sensor for the purpose of preventing collision and slowing down and notifying collision risk while driving, but the FCA cannot detect collisions that may occur at the top of the front of a cargo vehicle for logistics delivery, or collisions caused by uneven obstacles at the height of the cargo vehicle. It can be difficult to prevent accidents caused by these types of collisions.

### BRIEF DESCRIPTION OF THE DRAWINGS

FIG. 1 is a diagram illustrating a safe driving providing system according to an example embodiment.

FIG. 2 is a diagram illustrating a safe driving providing device according to an example embodiment.

FIG. 3 is a diagram illustrating a safe driving providing method according to an example embodiment.

FIG. 4 is a diagram illustrating a safe driving providing method according to the example embodiment.

FIG. 5 is a diagram illustrating a server according to an example embodiment.

FIG. 6 is a diagram illustrating the safe driving providing method according to the example embodiment.

FIG. 7 is a diagram illustrating the safe driving providing method according to the example embodiment.

FIGS. 8 and 9 are diagrams for illustrating example implementations of the safe driving providing method and device according to the example embodiment.

FIGS. 10 and 11 are diagrams for illustrating example implementations of the safe driving providing method and device according to the example embodiment.

FIG. 12 is a diagram illustrating a computing device according to an example embodiment.

### DETAILED DESCRIPTION

Hereinafter, the present disclosure will be described more fully hereinafter with reference to the accompanying drawings, in which example embodiments of the disclosure are shown. As those skilled in the art would realize, the described example embodiments may be modified in various different ways, without departing from the spirit or scope of the present disclosure. Accordingly, the drawings and description are to be regarded as illustrative in nature and not restrictive. Like reference numerals designate like elements throughout the specification.

Throughout the specification and the claims, unless explicitly described to the contrary, the word “comprise”, and variations such as “comprises” or “comprising”, will be understood to imply the inclusion of stated elements but not the exclusion of any other elements. Terms including an ordinary number, such as first and second, are used for describing various components, but the components are not limited by the terms. The terms are used to discriminate one component from another component.

Terms such as “part,” “unit,” “module,” and the like in the specification may refer to a unit capable of performing at least one function or operation described herein, which may be implemented in hardware or circuitry, software, or a combination of hardware or circuitry and software. In addition, at least some of the configurations or functions of a safe driving providing method and device according to the example embodiments described below may be implemented as programs or software, and the programs or software may be stored on a computer-readable medium.

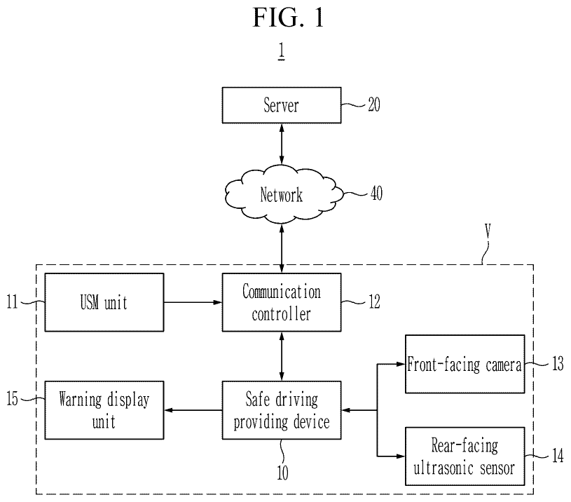

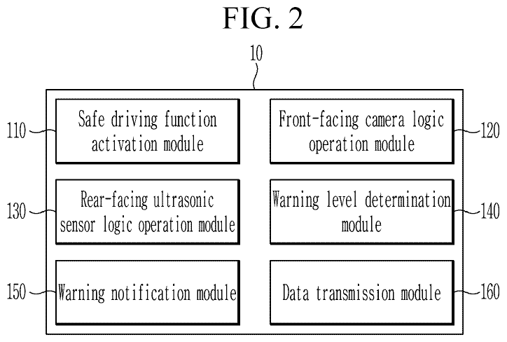

FIG. 1 is a diagram illustrating a safe driving providing system according to an example embodiment, and FIG. 2 is a diagram illustrating a safe driving providing device according to an example embodiment.

Referring to FIGS. 1 and 2, a safe driving providing system 1 according to one example embodiment may include a vehicle V including a safe driving providing device 10 and a server 20. The vehicle V and the server 20 may exchange data (e.g., with each other) through a network 40. For example, the vehicle V may transmit terrain information about a delivery destination to the server 20 through communication with the network 40, and the vehicle V may receive information related to dispatching and a route from the server 20. In some example embodiments, the vehicle V may communicate with the server 20 through a cellular network, including 4G, 5G, and the like.

In the present example embodiment, the vehicle V may include the safe driving providing device 10, a User Setting Mode (USM) unit 11, a communication controller 12, a front-facing camera 13, a rear-facing ultrasonic sensor 14, and a warning display unit 15. The USM unit 11 may provide a function to allow a user (e.g., a driver of the cargo vehicle V for logistics delivery) to set internal controls (e.g., controllers) for personalization. The user may adjust various functions and settings of the vehicle V by using the USM unit 11, and for example, the user may obtain a personalized driving experience and convenience through generating and storing profiles, adjusting settings of audio, navigation, communication devices, and the like, adjusting settings of driving assistance systems, changing settings of the dashboard and interior lighting, setting climate control, locking and security settings, setting driving modes, and the like. In some example embodiments, the USM unit 11 may be implemented to display a user interface and receive settings input from a user through a vehicle infotainment system or a user terminal possessed by the user and running a driver mobile application.

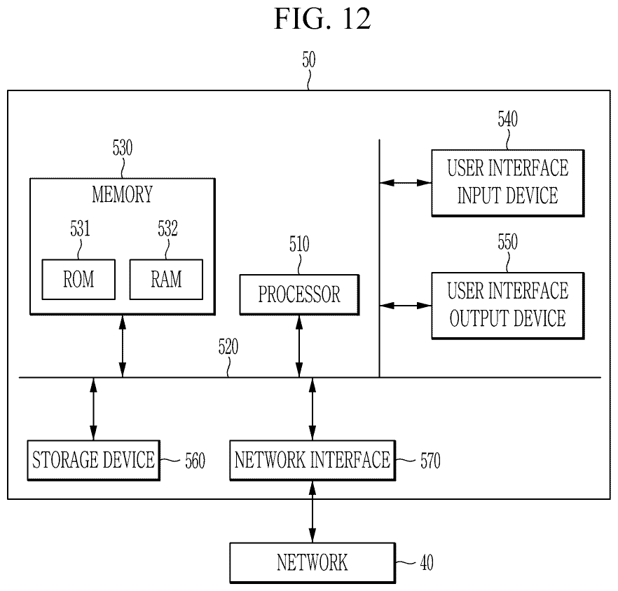

The safe driving providing device 10 may execute a program code loaded into one or more memory devices through one or more processors. For example, the safe driving providing device 10 may be implemented as a computing device 50 (e.g., described later with reference to FIG. 12). In this case, the one or more processors may correspond to a processor 510 of the computing device 50, and the one or more memory devices may correspond to a memory 530 of the computing device 50. The program code may be executed by the one or more processors to perform operations to provide safe driving of the cargo vehicle V for logistic delivery. The term “module” is used herein to (e.g., logically) distinguish between these functions executed by the program code.

The safe driving providing device 10 may include a safe driving function activation module 110, a front-facing camera logic operation module 120, a rear-facing ultrasonic sensor logic operation module 130, a warning level determination module 140, a warning notification module 150, and a data transmission module 160.

The safe driving function activation module 110 may be set for the safe driving providing mode to be enabled or disabled on the USM. Specifically, the user may set the safe driving providing mode to be enabled or disabled through the USM unit 11.

When the safe driving providing mode is activated, the safe driving function activation module 110 may check for predetermined safe driving providing mode operating conditions. Specifically, the safe driving function activation module 110 may determine whether a condition that a key of the cargo vehicle V is located at an ignition one IGN1 and a vehicle speed of the cargo vehicle V is less than a predetermined reference speed is satisfied. Here, the predetermined reference speed may be determined experimentally by collecting data on the speed at which the cargo vehicle V (e.g., typically) travels at the delivery destination. For example, the predetermined reference speed may be 10 kph (kilometer per hour).

When it is determined that the condition that the key is at the ignition one IGN1 and the vehicle speed of the cargo vehicle V is less than the predetermined reference speed is satisfied, the safe driving function activation module 110 may determine the gear position of the cargo vehicle V. When the gear position is D, the front-facing camera logic operation module 120 may be operated, and when the gear position is R, the rear-facing ultrasonic sensor logic operation module 130 may be operated.

When the front-facing camera logic operation module 120 determines that the gear position is D, the front-facing camera logic operation module 120 may measure the height of the topmost end from the ground through the front-facing camera mounted on the front face of the cargo vehicle V. When the height of the topmost end has been measured, the warning level determination module 140 may determine a grade of a forward collision warning level rating by using the measured height and the (e.g., overall) height of the cargo vehicle V.

The forward collision warning level may be divided into a plurality of levels. Specifically, the warning levels may be differentiated by taking into account the difference between the overall height of the cargo vehicle V, that is, the height from the bottom of the tires in contact with the ground at an unloading situation to the highest roof of the vehicle body, and the measured height of the topmost end. For example, when the overall height of the cargo vehicle V is h and the height of the topmost end is measured to be h+50 cm, the forward collision warning level corresponding to a first grade corresponds to h+50 cm, the forward collision warning level corresponding to a second grade corresponds to h+30 cm, and the forward collision warning level corresponding to a third grade corresponds to h+15 cm. In other words, as the clearance between the overall height of the vehicle V and the height of the topmost end of the delivery destination decreases, the grade of the forward collision warning level may increase. As a result, the driver may take actions, such as further reducing the speed of the cargo vehicle V to drive the cargo vehicle V or paying more attention when receiving the forward collision warning with the third grade than when receiving the forward collision warning with the first grade.

The warning level determination module 140 may determine the forward collision warning level as the first grade when the difference between the height of the topmost end and the overall height of the cargo vehicle V is a first value. In one example, the warning level determination module 140 may determine the forward collision warning level as the second grade when the difference between the height of the topmost end and the overall height of the cargo vehicle V is a second value which is smaller than the first value. In one example, the warning level determination module 140 may determine the forward collision warning level as the third grade when the difference between the height of the topmost end and the overall height of the cargo vehicle V is a third value which is smaller than the second value.

The warning notification module 150 may output the forward collision level graded by the warning level determination module 140 through one or more output interfaces installed within the vehicle V. For example, the warning notification module 150 may output the graded forward collision level through a cluster, center fascia, or the like of the vehicle V.

The data transmission module 160 may transmit to the server 20, by using a central communication unit (CCU) 12 of the cargo vehicle V, the data of the height of the topmost end measured by the front-facing camera logic operation module 120 and the position data of the cargo vehicle V at the time of the measurement of the topmost end.

On the other hand, when it is determined that the gear position is R, the rear-facing ultrasonic sensor logic operation module 130 may detect an obstacle having a predetermined height (e.g., or more) through a rear-facing ultrasonic sensor mounted on the rear face of the cargo vehicle V. When an obstacle is detected, the warning level determination module 140 may determine a grade of the rearward collision warning level by using a distance between the detected obstacle and the cargo vehicle V.

The rearward collision warning level may be divided into a plurality of grades. Specifically, the levels of warning may be differentiated depending on the distance of the cargo vehicle V from the obstacle. For example, when the distance of the cargo vehicle V from the obstacle is measured as d, the rearward collision warning level corresponding to a first grade may correspond to a distance of d<150 cm, the rearward collision warning level corresponding to a second grade may correspond to a distance of d<80 cm, and the rearward collision warning level corresponding to a third grade may correspond to a distance of d<30 cm. In other words, as the clearance between the vehicle V and the obstacle decreases, the grade of the forward collision warning level may increase. As a result, the driver may take actions, such as further reducing the speed of the cargo vehicle V to drive the cargo vehicle V or paying more attention when receiving the rearward collision warning with the third grade than when receiving the rearward collision warning with the first grade.

When the distance between the detected obstacle and the cargo vehicle V is equal to or less than a first value, the warning level determination module 140 may determine the rearward collision warning level to be the first grade. In one example, when the distance between the detected obstacle and the cargo vehicle V is equal to or less than a second value that is less than the first value, the warning level determination module 140 may determine the rearward collision warning level to be the second grade. In one example, when the distance between the detected obstacle and the cargo vehicle V is equal to or less than a third value that is less than the second value, the warning level determination module 140 may determine the rearward collision warning level to be the third grade.

The warning notification module 150 may output the rearward collision warning level graded by the warning level determination module 140 through one or more output interfaces installed within the vehicle V. For example, the warning notification module 150 may output the graded rearward collision level through a cluster, center fascia, or the like of the vehicle V.

In some example embodiments, at least one of the safe driving function activation module 110, the front-facing camera logic operation module 120, the rear-facing ultrasonic sensor logic operation module 130, the warning level determination module 140, the warning notification module 150, and the data transmission module 160 may perform the operation repeatedly according to a preset period, for example, 10 ms (millisecond). Furthermore, the front-facing camera logic operation module 120 and the rear-facing ultrasonic sensor logic operation module 130 may alternately perform the operation according to the gear position of the cargo vehicle V.

According to one example embodiment, detailed terrain may be identified at a delivery destination, such as an underground parking lot, by measuring the height of the topmost end or detecting obstacles having a predetermined height or more. Accordingly, the driver may react to prevent a collision accident, such as collision with the front top of the vehicle or collision with a rear uneven obstacle.

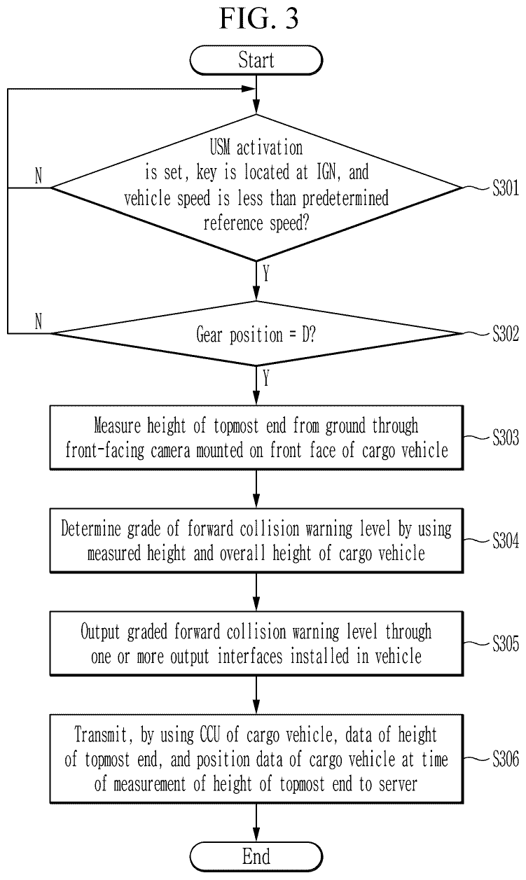

FIG. 3 is a diagram illustrating a safe driving providing method according to an example embodiment.

Referring to FIG. 3, the safe driving providing method according to the example embodiment may include determining whether conditions that the USM activation is set, the key is located at the IGN, and a vehicle speed is less than a predetermined reference are satisfied (S301). When it is determined the condition is not satisfied (S301, ‘N’), the safe driving providing method may proceed (e.g., return) to operation S301.

When it is determined the condition is satisfied (S301, ‘Y’), the safe driving providing method may proceed to determining whether a gear position is D (S302). When it is determined that the gear position is not D (S302, ‘N’), the safe driving providing method may proceed (e.g., return) to operation S301.

When it is determined that the gear position is D (S302, ‘Y’), the safe driving providing method may perform measuring a height of the topmost end from the ground through a front-facing camera mounted on the front face of the cargo vehicle (S303), and determining a grade of a forward collision warning level by using the measured height and an overall height of the cargo vehicle (S304).

In some example embodiments, operation S304 may include determining the forward collision warning level to be a first grade when a difference between the height of the topmost end and the overall height of the cargo vehicle is a first value, determining the forward collision warning level to be a second grade when the difference between the height of the topmost end and the overall height of the cargo vehicle is a second value which is smaller than the first value, and determining the forward collision warning level to be a third grade when the difference between the height of the topmost end and the overall height of the cargo vehicle is a third value which is smaller than the second value.

The safe driving providing method may (e.g., then) additionally perform at least one operation of outputting the graded forward collision warning level through one or more output interfaces installed in the vehicle (S305), and transmitting, by using the CCU of the cargo vehicle, data of the height of the topmost end, and position data of the cargo vehicle at the time of the measurement of the height of the topmost end to the server (S306). In FIG. 3, an arrow is shown between operations S305 and S306, but the arrow does not limit the order in which operations S305 and S306 are performed. One or both of operations S305 and S306 may be performed, or operations S305 and S306 may be performed independently (e.g., of each other) in no particular order.

For further details of the above methods, reference may be made to the example embodiments described herein, so that duplicative description is omitted herein.

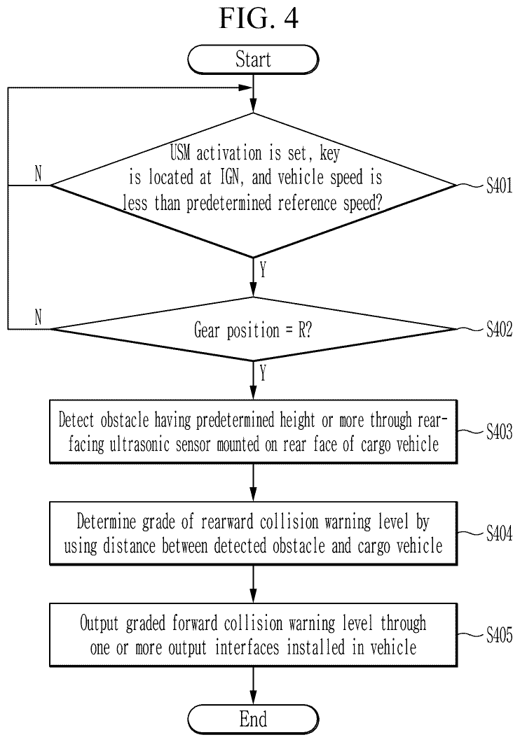

FIG. 4 is a diagram illustrating the safe driving providing method according to the example embodiment.

Referring to FIG. 4, the safe driving providing method according to the example embodiment may include determining whether conditions that the USM activation is set, the key is located at the IGN, and a vehicle speed is less than a predetermined reference are satisfied (S401). When it is determined the condition is not satisfied (S401, ‘N’), the safe driving providing method may proceed (e.g., return) to operation S401.

When it is determined that the condition is satisfied (S401, ‘Y’), the safe driving providing method may proceed to determining whether a gear position is R (S402). When it is determined that the gear position is not R (S402, ‘N’), the safe driving providing method may proceed to operation S401.

When it is determined that the gear position is R (S402, ‘Y’), the safe driving providing method may perform detecting an obstacle having a predetermined height or more through a rear-facing ultrasonic sensor mounted on the rear face of the cargo vehicle (S403), and determining a grade of the rearward collision warning level by using a distance between the detected obstacle and the cargo vehicle (S404).

In some example embodiments, operation S404 may include determining the rearward collision warning level to be a first grade when a distance between the detected obstacle and the cargo vehicle is a first value or less, determining the rearward collision warning level to be a second grade when the distance between the detected obstacle and the cargo vehicle is a second value or less which is smaller than the first value, and determining the rearward collision warning level to be a third grade when the distance between the detected obstacle and the cargo vehicle is a third value which is smaller than the second value.

The safe driving providing method may (e.g., then) further perform outputting the graded forward collision warning level through one or more output interfaces installed in the vehicle (S405).

For further details of the above methods, reference may be made to the example embodiments described herein, so that duplicative description is omitted herein.

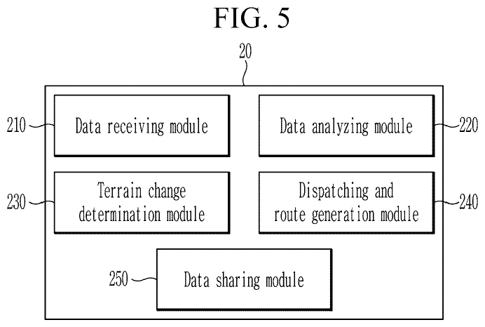

FIG. 5 is a diagram illustrating a server according to an example embodiment.

Referring to FIG. 5, the server 20 according to the example embodiment may execute program codes loaded into one or more memory devices through one or more processors. For example, the server 20 may be implemented as the computing device 50, such as that described later with reference to FIG. 12. In this case, the one or more processors may correspond to a processor 510 of the computing device 50, and the one or more memory devices may correspond to a memory 530 of the computing device 50. The program code may be executed by the one or more processors to communicate with the cargo vehicle V for logistic delivery and perform operations to provide safe driving. The term “module” is used herein to logically distinguish between these functions executed by the program code.

The server 20 may include a data receiving module 210, a data analyzing module 220, a terrain change determination module 230, a dispatching and route generation module 240, and a data sharing module 250.

The data receiving module 210 may receive, from the cargo vehicle V, data of a height of the topmost end obtained by measuring the height of the topmost end from the ground through the front-facing camera mounted on the front face of the cargo vehicle V. Further, the data receiving module 210 may receive, from the cargo vehicle V, position data of the cargo vehicle V at the time of the measurement of the height of the topmost end. Specifically, the data receiving module 210 may receive the data of the height of the topmost end and the position data from the data transmission module 160 of the cargo vehicle V.

The data analyzing module 220 may compute an average value by collecting N data of the height of the topmost end for the same location, where N is an integer equal to or greater than 2. For example, the data analyzing module 220 may collect data samples of the height of the topmost end at a specific location at a specific delivery destination through communication with the cargo vehicle V, and compute an average value for these samples and use the computed average value as an indicator of the terrain at the corresponding location. In other words, the average value may be used as an index related to the height of the topmost end of the terrain at the corresponding location.

The terrain change determination module 230 may determine whether there is a change of a predetermined first percentage or more by receiving the N+1th data of the height of the topmost end for the same location using the data receiving module 210, and comparing the N+1th data of the highest of the topmost end with the average value computed by the data analyzing module 220. For example, after an average value is calculated from 10 data samples of the height of the topmost end for a specific location, the terrain change determination module 230 may compare the 11th data of the height of the topmost end with the average value to determine whether there is a change of, for example, 10% or more. When there is the change of 10% or more, the terrain change determination module 230 may determine that a terrain change, that is, a change in the height of the topmost end, at the corresponding location has occurred at the corresponding delivery destination.

When it is determined by the terrain change determination module 230 that there is the change of a first percentage or more, the dispatching and route generation module 240 may reflect the data of the height of the topmost end into the dispatching and route generation of other cargo vehicles for logistics delivery. For example, when it is determined that the height of the topmost end has decreased at the corresponding location at the corresponding delivery destination, this change may be reflected in the dispatching and route generation of other cargo vehicles for logistics delivery.

In some example embodiments, the dispatching and route generation module 240 may compute an enterable vehicle height value based on the data of the height of the topmost end and obtain disposed vehicle height values of the other cargo vehicles for logistics delivery. The dispatching and route generation module 240 may discover a disposing impossible route based on the enterable vehicle height value and the disposed vehicle height value. The dispatching and route generation module 240 may perform dispatching and route generation considering the discovered disposing impossible route.

In some example embodiments, the dispatching and route generation module 240 may, in order to perform dispatching and route generation in light of the discovered disposing impossible route, additionally dispose vehicles of which final routes change the least among vehicles disposed on routes that satisfy the vehicle height on the disposing impossible route.

The data sharing module 250 may share information indicating the presence of terrain changes based on the data of the height of the topmost end with other external servers, which may implement various application services utilizing the corresponding information.

In the meantime, the data receiving module 210 may receive, from the cargo vehicle V, data of a width of a front region obtained by measuring the width of the front region through the front-facing camera mounted on the front face of the cargo vehicle V. Further, the data receiving module 210 may receive, from the cargo vehicle V, position data of the cargo vehicle V at the time of the measurement of the width of the front region. Specifically, the data receiving module 210 may receive the data of the width of the front region and the position data from the data transmission module 160 of the cargo vehicle V.

The data analyzing module 220 may compute an average value by collecting M data of the width of the front region for the same location, where M is an integer equal to or greater than 2. For example, the data analyzing module 220 may collect data samples of the width of the front region end at a specific location at a specific delivery destination through communication with the cargo vehicle V, and compute an average value for these samples and use the computed average value as an indicator of the terrain at the corresponding location. In other words, the average value may be used as an index related to the width of the front region of the terrain at the location.

The terrain change determination module 230 may determine whether there is a change of a predetermined second percentage or more by receiving the M+1th data of the width of the front region for the same location using the data receiving module 210, and comparing the M+1th data of the width of the front region with the average value computed by the data analyzing module 220. For example, after an average value is calculated from 10 data samples of the width of the front region for a specific location, the terrain change determination module 230 may compare the 11th data of the width of the front region with the average value to determine when there is a change of, for example, 10% or more. When there is the change of 10% or more, the terrain change determination module 230 may determine that a terrain change, that is, a change in the width of the front region, at the corresponding location has occurred at the corresponding delivery destination.

When it is determined by the terrain change determination module 230 that there is the change of a second percentage or more, the dispatching and route generation module 240 may reflect the data of the width of the front region into the dispatching and route generation of other cargo vehicles for logistics delivery. For example, when it is determined that the width of the front region has decreased at the corresponding location at the corresponding delivery destination, this change may be reflected in the dispatching and route generation of other cargo vehicles for logistics delivery.

In some example embodiments, the dispatching and route generation module 240 may compute an enterable width value based on the data of the width of the front region and obtain disposed vehicle overall width values of the other cargo vehicles for logistics delivery. The dispatching and route generation module 240 may discover a disposing impossible route based on the enterable width value and the disposed vehicle overall width value. The dispatching and route generation module 240 may perform dispatching and route generation considering the discovered disposing impossible route.

In some example embodiments, the dispatching and route generation module 240 may, in order to perform dispatching and route generation in light of the discovered disposing impossible route, additionally dispose vehicles of which final routes change the least among vehicles disposed on routes that satisfy the overall width on the disposing impossible route.

The data sharing module 250 may share information indicating the presence of terrain changes based on the data of the width of the front region with other external servers, which may implement various application services utilizing the corresponding information.

According to the present example embodiment, detailed terrain may be identified at a delivery destination, such as an underground parking lot, by measuring the height of the topmost end or measuring the width of the front region. This may help prevent vehicle collisions, such as front top end collisions, and also share terrain information about the delivery destination with other vehicles, thereby significantly reducing the risk of accidents at the first delivery destination where the vehicle that receives the information arrives.

In some example embodiments, the server 20 may receive, from the cargo vehicle V, data of an impassable situation in front of the cargo vehicle V obtained by recognizing an impassable situation in front of the cargo vehicle V through the front-facing camera, receive position data of the cargo vehicle V upon recognizing the data of the impassable situation in front of the cargo vehicle V, and reflect the data of the impassable situation in front of the cargo vehicle V into the dispatching and route generation of other cargo vehicles for logistics delivery.

In some example embodiments, the server 20 may receive, from the cargo vehicle V, collision occurrence situation data obtained by recognizing a collision occurrence situation of the cargo vehicle V, receive position data of the cargo vehicle V upon recognizing the collision occurrence situation of the cargo vehicle V, and reflect the collision occurrence situation data into the dispatching and route generation of other cargo vehicles for logistics delivery. In some example embodiments, the server 20 may obtain data indicative of the number of times of vehicle trips at a specific point, compute a collision occurrence rate at the corresponding point by using the data indicative of the number of times of the vehicle trips and the collision occurrence situation data, and display the collision occurrence rate on a navigation map, in order to reflect the collision occurrence situation data into the dispatching and route generation of other cargo vehicles for logistics delivery.

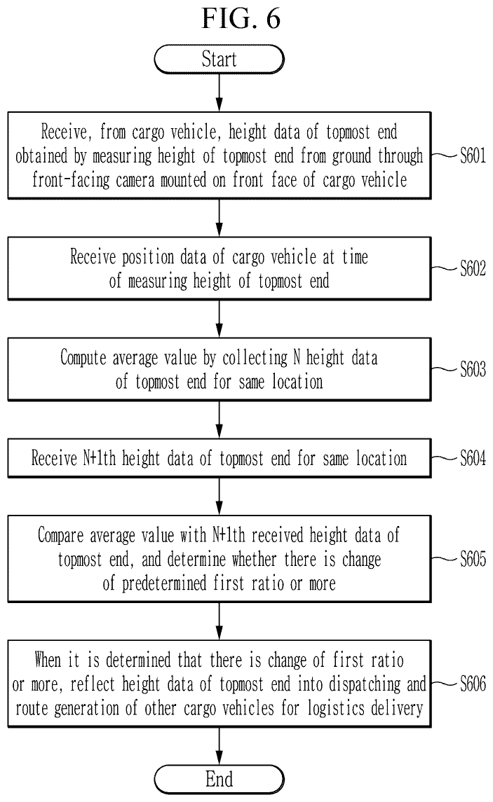

FIG. 6 is a diagram illustrating the safe driving providing method according to the example embodiment.

Referring to FIG. 6, a safe driving providing method according to an example embodiment may include receiving, from a cargo vehicle, height data of a topmost end obtained by measuring a height of the topmost end from the ground through a front-facing camera mounted on a front face of the cargo vehicle (S601), receiving position data of the cargo vehicle at the time of measuring the height of the topmost end (S602), computing an average value by collecting N height data of the topmost end for the same location (S603), receiving N+1th height data of the topmost end for the same location (S604), comparing the average value with the N+1th received height data of the topmost end, and determining whether there is a change of a predetermined first ratio or more (S605). Further, when it is determined that there is change of the first ratio or more, reflecting the height data of the topmost end into dispatching and route generation of other cargo vehicles for logistics delivery (S606).

For further details of the above methods, reference may be made to the example embodiments described herein, so that duplicative description is omitted herein.

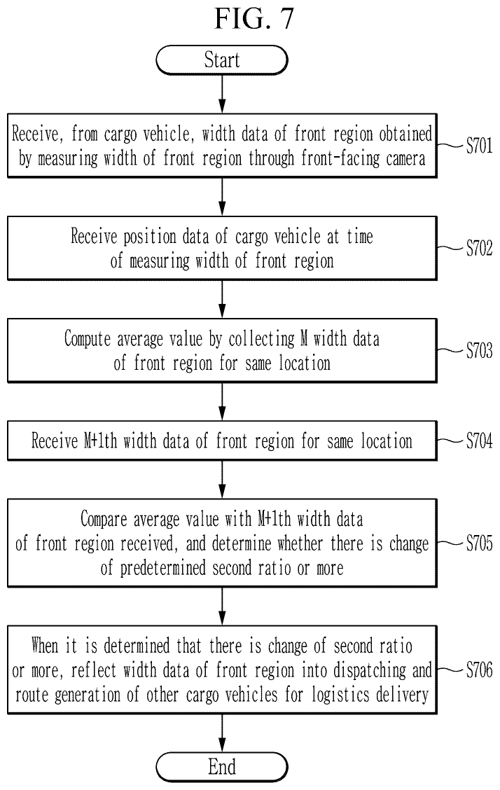

FIG. 7 is a diagram illustrating the safe driving providing method according to the example embodiment.

Referring to FIG. 7, a safe driving providing method according to an example embodiment may include receiving, from a cargo vehicle, width data of a front region obtained by measuring a width of a front region through the front-facing camera (S701), receiving position data of the cargo vehicle at the time of measuring the width of the front region (S702), computing an average value by collecting M width data of the front region for the same location (S703), receiving M+1th width data of the front region for the same location (S704), comparing the average value with the M+1th received width data of the front region, and determining whether there is a change of a predetermined second ratio or more (S705). Further, when it is determined that there is change of the second ratio or more, reflecting the width data of the front region into dispatching and route generation of other cargo vehicles for logistics delivery (S706).

For further details of the above methods, reference may be made to the example embodiments described herein, so that duplicative description is omitted herein.

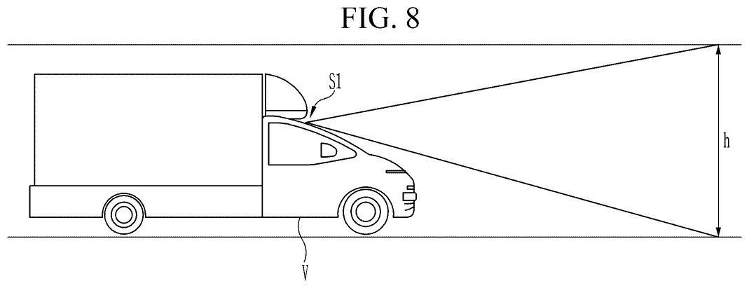

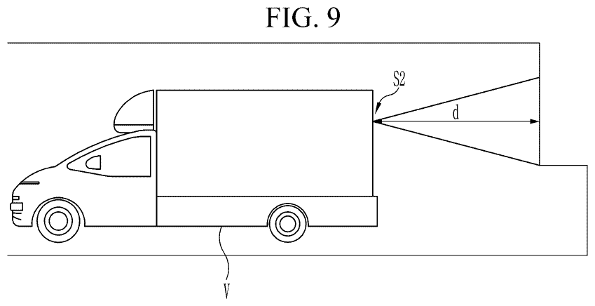

FIGS. 8 and 9 are diagrams for illustrating example implementations of the safe driving providing method and device according to the example embodiment.

Referring to FIG. 8, when it is determined that the gear position is D, the height h of the topmost end from the ground may be measured through a front-facing camera mounted on a front face S1 of the cargo vehicle V. After the height of the topmost end is measured, a forward collision warning level is determined as a grade by using the measured height and the overall height of the cargo vehicle V, and forward collision warnings may be provided to the driver accordingly.

Referring to FIG. 9, when it is determined that the gear position is R, a rear-facing ultrasonic sensor mounted on a rear face S2 of the cargo vehicle V may detect an obstacle having a predetermined height or more. After the obstacle is detected, a rearward collision warning level may be determined as a grade by using a distance d between the detected obstacle and the cargo vehicle V, and a forward collision warning may be provided to the driver accordingly.

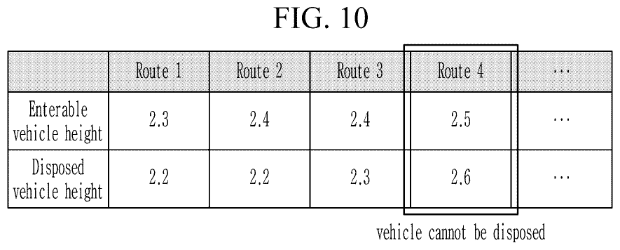

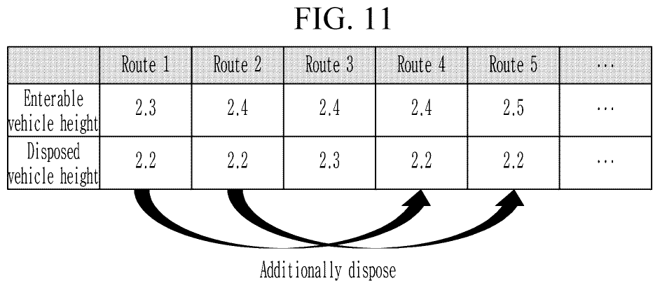

FIGS. 10 and 11 are diagrams for illustrating example implementations of the safe driving providing method and device according to the example embodiment.

Referring to FIG. 10, in dispatching vehicles, a route based on the logistics situation is first generated, and then vehicles may be re-disposed by comparing enterable vehicle heights and disposed vehicle heights within the generated route. For example, the enterable vehicle heights and the disposed vehicle heights after the routes are generated are 2.3 and 2.2 for route 1, 2.4 and 2.2 for route 2, and 2.4 and 2.3 for route 3. However, for route 4, the enterable vehicle height is 2.5, but the disposed vehicle height is 2.6, so that the vehicle cannot be disposed.

Referring to FIG. 11, when there is a route, such as route 4, in which it is impossible to dispose the cargo vehicle, the vehicle may be re-disposed by separating the route into two routes and adding a route. In this case, among the vehicles disposed on the route that satisfies the vehicle height, a vehicle on the route of which the final route is changed the least may be additionally disposed. For example, route 4 in FIG. 10 may be separated into route 4 and route 5 in FIG. 11 and vehicles may be re-disposed as illustrated.

FIG. 12 is a diagram illustrating a computing device according to an example embodiment.

Referring now to FIG. 12, the safe driving providing method and device for the vehicle according to the example embodiments may be implemented by using a computing device 50.

The computing device 50 may include at least one of a processor 510, a memory 530, a user interface input device 540, a user interface output device 550, and a storage device 560 communicating through a bus 520. The computing device 50 may also include a network interface 570 electrically connected to the network 40. The network interface 570 may transmit or receive a signal with another entity through the network 40.

The processor 510 may be implemented in various types, such as a micro controller unit (MCU), application processor (AP), a central processing unit (CPU), a graphic processing unit (GPU), a neutral processing unit (NPU), and a quantum processing unit (QPU), and may be a predetermined semiconductor device executing commands stored in the memory 530 or the storage device 560. The processor 510 may be configured to implement the function and the methods described above with reference to FIGS. 1 to 11.

The memory 530 and the storage device 560 may include various forms of volatile or non-volatile storage media. For example, the memory may include a read only memory (ROM) 531 and a random access memory (RAM) 532. In the example embodiment, the memory 530 may be located inside or outside the processor 510, and the memory 530 may be connected with the processor 510 through already known various means.

In some example embodiments, at least some configurations or functions of the safe driving providing method and device for the vehicle according to the example embodiments may be implemented as programs or software executed on the computing device 50, and the programs or software may be stored on a computer-readable medium. Specifically, a computer-readable medium according to the example embodiment may record a program for executing the operations included in the safe driving providing method for the vehicle according to the example embodiments on a computer including the processor 510 executing a program or instructions stored in the memory 530 or the storage device 560.

In some example embodiments, at least some configurations or features of the safe driving providing method and device for the vehicle according to the example embodiments may be implemented using hardware or circuit of the computing device 50, or may be implemented as separate hardware or circuit that may be electrically connected to the computing device 50.

According to the example embodiments, detailed terrain may be identified at a delivery location, such as an underground parking lot, by measuring the height of the topmost end or detecting obstacles having a predetermined height or more. This may help prevent vehicle collisions, such as front top end collisions or rear uneven obstacle collisions, and also share terrain information about the delivery destination with other vehicles, thereby significantly reducing the risk of accidents at the first delivery destination where the vehicle that receives the information arrives.

Although the above example embodiments of the present disclosure have been described in detail, the scope of the present disclosure is not limited thereto, but also includes various modifications and improvements by one of ordinary skill in the art utilizing the basic concepts of the present disclosure as defined in the following claims.

What is claimed is:

1. A safe driving providing method of providing safe driving of a cargo vehicle for logistics delivery, the safe driving providing method comprising:
determining whether a condition is satisfied in which a safe driving providing mode is set to be activated in a user setting mode (USM), a key is located at an ignition one (IGN1), and a vehicle speed of the cargo vehicle is less than a predetermined reference speed;
when it is determined that the condition is satisfied, determining a gear position of the cargo vehicle;
when the gear position is D, measuring a height of a topmost end from a ground through a front-facing camera mounted on a front face of the cargo vehicle;
determining a grade of a forward collision warning level by using the measured height and an overall height of the cargo vehicle;
outputting the graded forward collision warning level through one or more output interfaces installed in the cargo vehicle; and
transmitting data of the height of the topmost end and position data of the cargo vehicle at a time of measuring the height of the topmost end to a server by using a central communication unit (CCU) of the cargo vehicle.

2. The safe driving providing method of claim 1, wherein
the determining of the grade of the forward collision warning level includes:
determining the forward collision warning level to be a first grade when a difference between the height of the topmost end and the overall height of the cargo vehicle is a first value; and
determining the forward collision warning level to be a second grade when the difference between the height of the topmost end and the overall height of the cargo vehicle is a second value which is smaller than the first value.

3. The safe driving providing method of claim 2, wherein
the determining of the grade of the forward collision warning level further includes:
determining the forward collision warning level to be a third grade when the difference between the height of the topmost end and the overall height of the cargo vehicle is a third value which is smaller than the second value.

4. The safe driving providing method of claim 1, further comprising:
detecting an obstacle having a predetermined height or more when the gear position is R through a rear-facing ultrasonic sensor mounted on a rear face of the cargo vehicle;
determining a grade of a rearward collision warning level by using a distance between the detected obstacle and the cargo vehicle; and
outputting the graded rearward collision warning level through one or more output interfaces installed in the cargo vehicle.

5. The safe driving providing method of claim 4, wherein
the determining of the grade of the rearward collision warning level includes:
determining the rearward collision warning level to be a first grade when the distance between the detected obstacle and the cargo vehicle is equal to or less than a first value; and
determining the rearward collision warning level to be a second grade when the distance between the detected obstacle and the cargo vehicle is equal to or less than a second value which is smaller than the first value.

6. The safe driving providing method of claim 5, wherein
the determining of the grade of the rearward collision warning level further includes
determining the rearward collision warning level to be a third grade when the distance between the detected obstacle and the cargo vehicle is a third value which is smaller than the second value.

7. A safe driving providing method of providing safe driving of a cargo vehicle for logistics delivery, the safe driving providing method comprising:
receiving, from a cargo vehicle, data of a height of the topmost end obtained by measuring the height of the topmost end from a ground through a front-facing camera mounted on a front face of the cargo vehicle;
receiving position data of the cargo vehicle at a time of measuring the height of the topmost end;
computing an average value by collecting N data of the height of the topmost end for the same location, wherein N is an integer equal to or greater than 2;
receiving N+1th data of the height of the topmost end for the same location;
comparing the N+1th received data of the height of the topmost end with the average value to determine whether there is a change of a predetermined first percentage or more; and
when it is determined that there is the change of the first percentage or more, reflecting the data of the height of the topmost end in dispatching and route generation of other cargo vehicles for logistics delivery.

8. The safe driving providing method of claim 7, wherein
the reflecting of the data of the height of the topmost end into the dispatching and route generation of the other cargo vehicles for logistics delivery includes:
computing an enterable vehicle height value based on the data of the height of the topmost end;
obtaining disposed vehicle height values for the other cargo vehicles for logistics delivery;
discovering a disposing impossible route based on the enterable vehicle height value and the disposed vehicle height value; and
performing the dispatching and route generation by taking into account of the discovered disposing impossible route.

9. The safe driving providing method of claim 8, wherein
the performing of the dispatching and route generation by taking into account of the discovered disposing impossible route includes
additionally disposing a vehicle on a route of which a final route changes the least among vehicles disposed on routes that satisfy the vehicle height on the disposing impossible route.

10. The safe driving providing method of claim 7, further comprising:
receiving, from the cargo vehicle, data of a width of a front region obtained by measuring a width of the front region through the front-facing camera;
receiving position data of the cargo vehicle at a time of measuring the width of the front region;
computing an average value by collecting M data of the width of the front region for the same location, wherein M is an integer equal to or greater than 2;
receiving M+1th data of the width of the front region for the same location;
comparing the M+1th received data of the width of the front region with the average value to determine whether there is a change of a predetermined second percentage or more; and
when it is determined that there is the change of the second percentage or more, reflecting the data of the width of the front region in dispatching and route generation of other cargo vehicles for logistics delivery.

11. The safe driving providing method of claim 10, further comprising
sharing information indicative of presence of a terrain change based on at least one of the data of the height of the topmost end and the data of the width of the front region to another external server.

12. The safe driving providing method of claim 7, further comprising
receiving, from the cargo vehicle, data of an impassable situation of a front region obtained by recognizing the impassable situation of the front region through the front-facing camera;
receiving position data of the cargo vehicle at a time of recognizing the impassable situation of the front region; and
reflecting the data of the impassable situation of the front region into the dispatching and route generation of other cargo vehicles for logistics deliveries.

13. The safe driving providing method of claim 7, further comprising
receiving, from the cargo vehicle, collision occurrence situation data obtained by recognizing a collision occurrence situation of the cargo vehicle;
receiving position data of the cargo vehicle upon recognizing the collision occurrence situation of the cargo vehicle; and
reflecting the collision occurrence situation data in the dispatching and route generation of other cargo vehicles for logistics delivery.

14. The safe driving providing method of claim 13, wherein
the reflecting of the collision occurrence situation data in the dispatching and route generation of other cargo vehicles for logistics delivery includes:
obtaining data indicative of a number of vehicle trips at a point;
computing a collision occurrence rate for the point by using the data representing the number of vehicle trips and the collision occurrence situation data; and
displaying the collision occurrence rate on a navigation map.

15. A safe driving providing device for providing safe driving of a cargo vehicle for logistics delivery, the safe driving providing device executing a program code loaded in one or more memory devices through one or more processors,
wherein the program code is executed to
determine whether a condition is satisfied in which a safe driving providing mode is set to be activated in a user setting mode (USM), a key is located at an ignition one (IGN1), and a vehicle speed of the cargo vehicle is less than a predetermined reference speed,
when it is determined that the condition is satisfied, determine a gear position of the cargo vehicle,
when the gear position is D, measure a height of a topmost end from a ground through a front-facing camera mounted on a front face of the cargo vehicle,
determine a grade of a forward collision warning level by using the measured height and an overall height of the cargo vehicle,
output the graded forward collision warning level through one or more output interfaces installed in the cargo vehicle, and
transmit data of the height of the topmost end and position data of the cargo vehicle at a time of measuring the height of the topmost end to a server by using a central communication unit (CCU) of the cargo vehicle.

16. The safe driving providing device of claim 15, wherein
the determining of the grade of the forward collision warning level includes:
determining the forward collision warning level to be a first grade when a difference between the height of the topmost end and the overall height of the cargo vehicle is a first value; and
determining the forward collision warning level to be a second grade when the difference between the height of the topmost end and the overall height of the cargo vehicle is a second value which is smaller than the first value.

17. The safe driving providing device of claim 16, wherein
the determining of the grade of the forward collision warning level further includes
determining the forward collision warning level to be a third grade when the difference between the height of the topmost end and the overall height of the cargo vehicle is a third value which is smaller than the second value.

18. The safe driving providing device of claim 15, wherein
the program code is executed to further
detect an obstacle having a predetermined height or more when the gear position is R through a rear-facing ultrasonic sensor mounted on a rear face of the cargo vehicle,
determine a grade of a rearward collision warning level by using a distance between the detected obstacle and the cargo vehicle, and
output the graded rearward collision warning level through one or more output interfaces installed in the cargo vehicle.

19. The safe driving providing device of claim 18, wherein
the determining of the grade of the rearward collision warning level includes:
determining the rearward collision warning level to be a first grade when the distance between the detected obstacle and the cargo vehicle is equal to or less than a first value; and
determining the rearward collision warning level to be a second grade when the distance between the detected obstacle and the cargo vehicle is equal to or less than a second value which is smaller than the first value.

20. The safe driving providing device of claim 19, wherein
the determining of the grade of the rearward collision warning level further includes
determining the rear collision warning level to be a third grade when the distance between the detected obstacle and the cargo vehicle is a third value which is smaller than the second value.
